(19) United States
(12) Patent Application Publication
(10) Pub. No.: US 2026/0310419 A1
(43) Pub. Date: Oct. 8, 2026

(54) METHODS, SYSTEMS, AND DEVICES FOR PROVIDING A MULTI-AGENT FRAMEWORK TO ADJUST AUTOMATED SERVICES

(71) Applicant: JPMorgan Chase Bank, N.A., New York, NY (US)

(72) Inventors: Chandrasekharan N. Mana, Hoffman Estates, IL (US); Sundararaman Radhakrishnan, Bangalore (IN); Dhakshinamoorthy Balasubramanian, Bengaluru (IN); Shubham Dhiman, Panchkula (IN); Prasenjit Sen, Bangalore (IN); Santhosh Hiriyanna, Banggalore (IN); Dondeltan X V, Nagercoil (IN); Murugan Muthuswamy, Bengaluru (IN); Praveenkumar Dharmalingam, Chennai (IN)

(73) Assignee: JPMorgan Chase Bank, N.A., New York, NY (US)

(21) Appl. No.: 19/221,668

(22) Filed: May 29, 2025

(30) Foreign Application Priority Data
Apr. 4, 2025 (IN) 202511033311

(51) Int. Cl. G06F 8/10; G06Q 10/0639; G06Q 40/03

(52) U.S. Cl. CPC G06F 8/10; G06Q 10/06393; G06Q 40/03

(57) ABSTRACT

Aspects of the subject disclosure may include, for example, receiving user-generated input indicating a request for a data report to adjust a service, generating requirements for generating the data report, generating a data model for generating the data report, and verifying the requirements and the data model based on a group of data quality rules. Further embodiments include generating a connection to a data source associated with the service running, by a deployment agent, a deployment pipeline to generate the data report, receiving data from the data source via the connection according to the data model, generating the data report according to the requirements, the data report includes metadata. Additional embodiments include determining key performance indicators (KPIs) associated with the service from the data report, and adjusting the service based on the KPIs. Other embodiments are disclosed.

### CROSS-REFERENCE TO RELATED APPLICATION(S)

The instant application claims priority to India Patent Application Serial No. 202511033311 filed Apr. 4, 2025. All sections of the aforementioned application(s) are incorporated herein by reference in its entirety.

### FIELD OF THE DISCLOSURE

The subject disclosure relates to methods, systems, and devices for providing a multi-agent framework to adjust automated services.

### BACKGROUND

In today's data-driven world, organizations are increasingly reliant on timely and high-quality data to make informed decisions. However, the process of data collection (ingestion) and management is often fraught with challenges, including significant manual efforts and delays due to the need for collaboration among various teams. In the current state of the art, data ingestion and data management require manual generation of metadata and code, which can be time-consuming and prone to errors. Additionally, understanding and managing complex data models to ensure data consistency and governance across applications and services can be a daunting task. These inefficiencies hinder the ability of organizations to quickly access and utilize data, impacting their competitive edge. Moreover, the lack of automation in the data ingestion and management process results in bottlenecks and inefficiencies, as each step requires human intervention and validation. This not only slows down the process but also increases the risk of inconsistencies and errors.

### SUMMARY OF DISCLOSURE

One or more aspects of the subject disclosure include a device, comprising a processing system including a processor, and a memory that stores executable instructions that, when executed by the processing system, facilitate performance of operations. The operations can comprise receiving, by a product owner agent, user-generated input indicating a request for a data report for a product to adjust a service associated with the product, generating, by the product owner agent, a group of requirements associated with generating the data report utilizing an artificial intelligence (AI) software application, and generating, by an information architect agent, a data model for generating the data report utilizing the AI software application. Further operations comprise verifying, by a data steward agent, the group of requirements and the data model based on a group of data quality rules resulting in a verification, generating, by a technology agent, a connection to a data source associated with the service utilizing the AI software application, and running, by a deployment agent, a deployment pipeline to generate the data report. Additional operations can comprise receiving, by a validation agent, data from the data source via the connection according to the data model, and generating, by the validation agent, the data report according to the group of requirements. The data report includes metadata. Also, the operations can comprise determining, by the AI software application, a group of key performance indicators (KPIs) associated with the service from the data report, and adjusting, by the AI software application, the service based on the group of KPIs.

One or more aspects of the subject disclosure include a non-transitory machine-readable medium, comprising executable instructions that, when executed by a processing system including a processor, facilitate performance of operations. The operations can comprise receiving, by a product owner agent, user-generated input indicating a request for a data report for a product to adjust a service associated with the product, generating, by the product owner agent, a group of requirements associated with generating the data report utilizing an artificial intelligence (AI) software application, and generating, by an information architect agent, a data model for generating the data report utilizing the AI software application. Further operations can comprise verifying, by a data steward agent, the group of requirements and the data model based on a group of data quality rules resulting in a verification, generating, by a technology agent, a connection to a data source associated with the service utilizing the AI software application, running, by a deployment agent, a deployment pipeline to generate the data report, and receiving, by a validation agent, data from the data source via the connection according to the data model, generating, by the validation agent, the data report according to the group of requirements. The data report includes metadata. Additional operations can comprise determining, by the AI software application, a group of key performance indicators (KPIs) associated with the service from the data report, and adjusting, by the AI software application, the service based on the group of KPIs.

One or more aspects of the subject disclosure include a method implemented by a processing system including a processor. The method can comprise receiving, by a product owner agent, user-generated input indicating a request for a data report for a product to adjust a service associated with the product, generating, by the product owner agent, a group of requirements associated with generating the data report utilizing an artificial intelligence (AI) software application, and generating, by an information architect agent, a data model for generating the data report utilizing the AI software application. Further, the method can comprise verifying, by a data steward agent, the group of requirements and the data model based on a group of data quality rules resulting in a verification, generating, by a technology agent, a connection to a data source associated with the service utilizing the AI software application, and running, by a deployment agent, a deployment pipeline to generate the data report. In addition, the method can comprise receiving, by a validation agent, data from the data source via the connection according to the data model, and generating, by the validation agent, the data report according to the group of requirements. The data report includes metadata. Also, the method can comprise determining, by the AI software application, a group of key performance indicators (KPIs) associated with the service from the data report, and adjusting, by the AI software application, the service based on the group of KPIs.

### BRIEF DESCRIPTION OF THE DRAWINGS

Reference will now be made to the accompanying drawings, which are not necessarily drawn to scale, and wherein:

FIG. 1 and FIG. 2A are block diagrams illustrating example, non-limiting embodiments of a system functioning in accordance with various aspects described herein.

FIGS. 2B-2G and FIGS. 3A-3G depict illustrative embodiments of methods in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

### DETAILED DESCRIPTION

One or more embodiments include automation of the data ingestion and data management process through a multi-agent framework that leverages large language models (LLMs) to generate data reports for an automated service. This system can integrate AI-driven decision-making tools within the multi-agent framework, in which each agent is responsible for specific tasks in the data ingestion and data management process, from data collection to validation. The system automates traditional manual processes such as metadata generation, data modeling, and code creation, thereby reducing human intervention and ensuring consistency across applications. Additionally, the system can incorporate a workflow, allowing for real-time monitoring and adaptability to custom use cases. The use of LLMs for tasks such as data glossary lookup, standardization, and metadata creation further enhance the system's efficiency and accuracy, providing an approach to data management that ensures governance, transparency, and rapid data availability. Further embodiments can include determining KPIs from the data report generated from automated data ingestion and data management process for an automated service and adjusting the automated service accordingly.

An automated service can be a process or system that operates with minimal human intervention, using a computer system (e.g., a distributed computer system, virtual computer system, cloud computer system, etc.) to perform tasks and deliver outcomes efficiently and consistently. These automated services leverage software applications, which include implementing AI or machine learning (ML) to execute predefined tasks, respond to user-generated or computer-generated inputs, and adapt to changing conditions associated with the automated service without the need for, or include limited, manual oversight. Examples of automated services can include, but not limited to, loan origination and approval, fraud detection and prevention, regulatory compliance, customer relationship management, investment portfolio management, financial reporting and analysis, and payment processing.

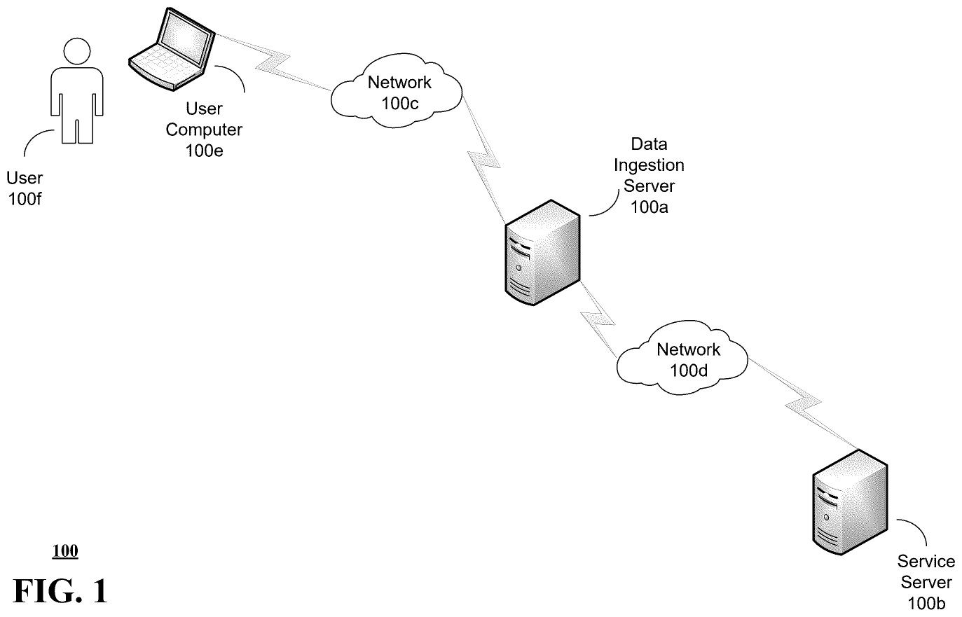

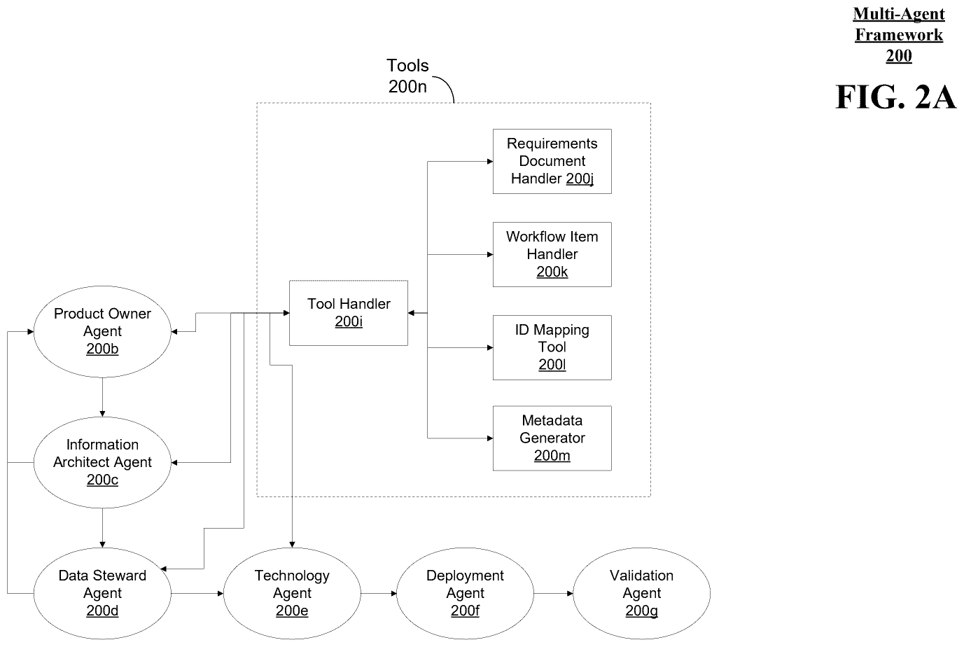

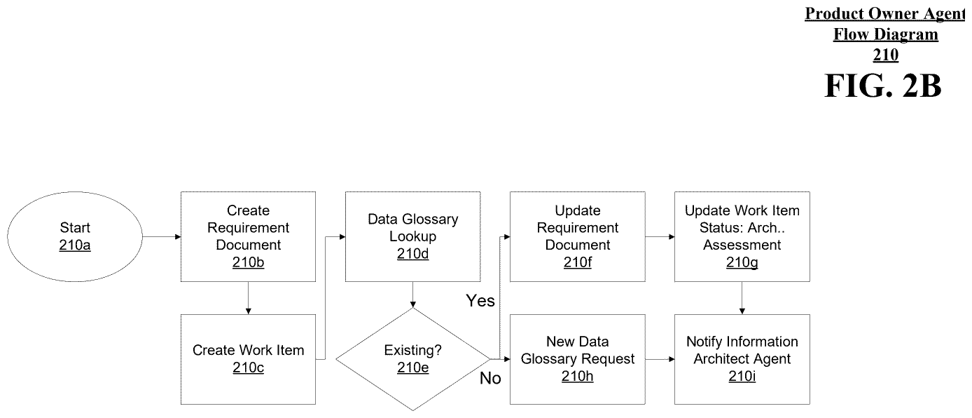

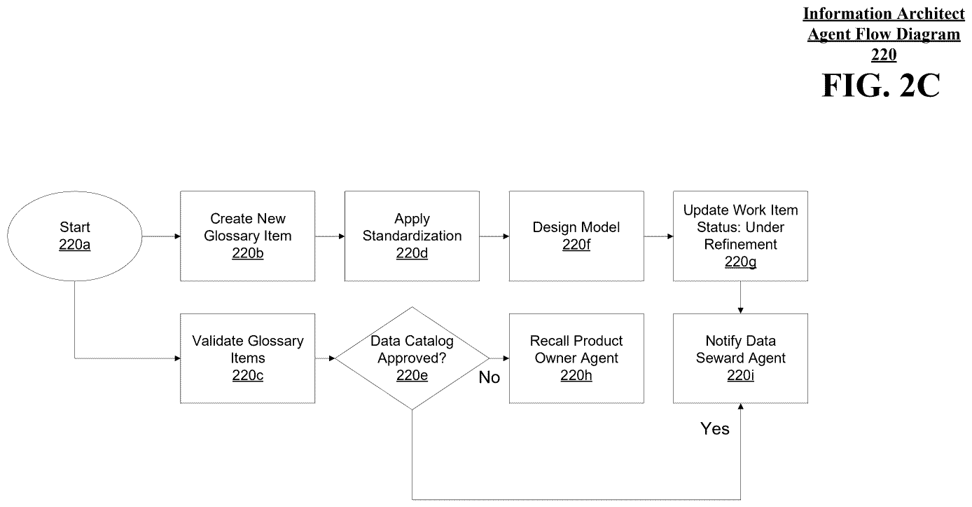

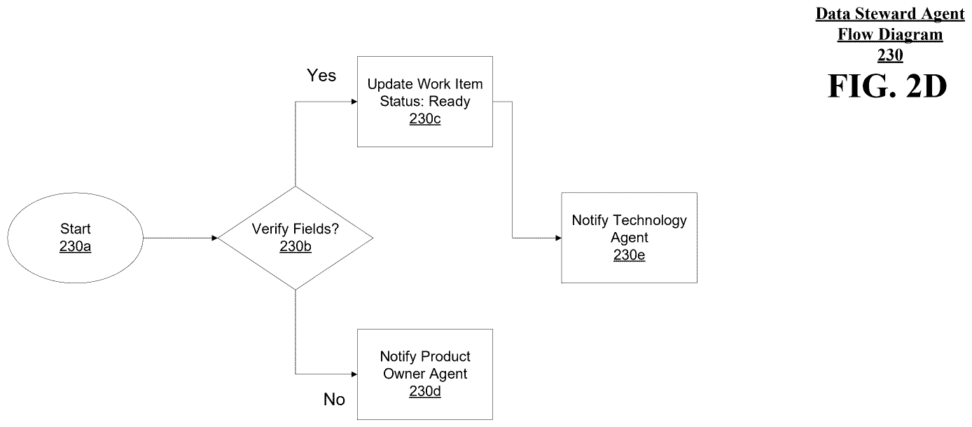

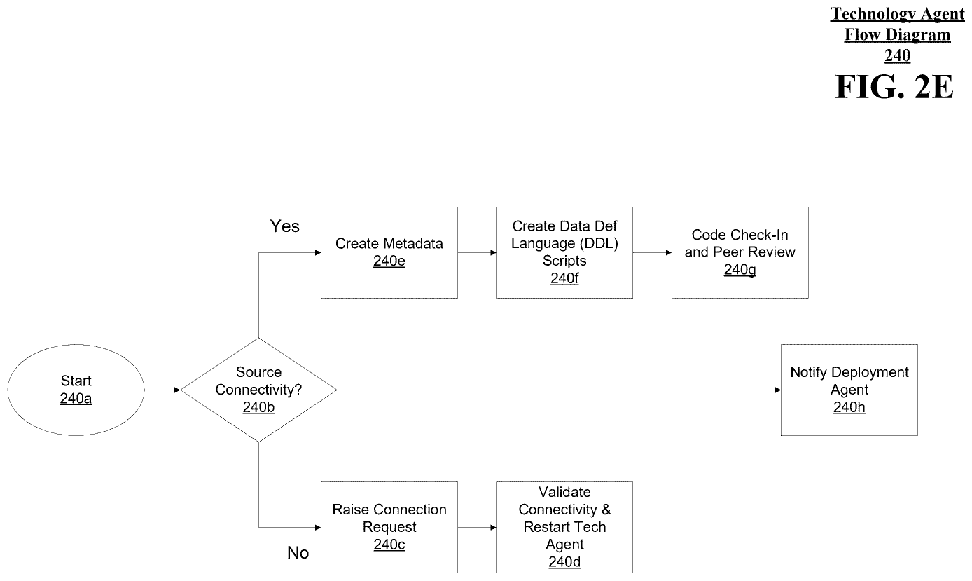

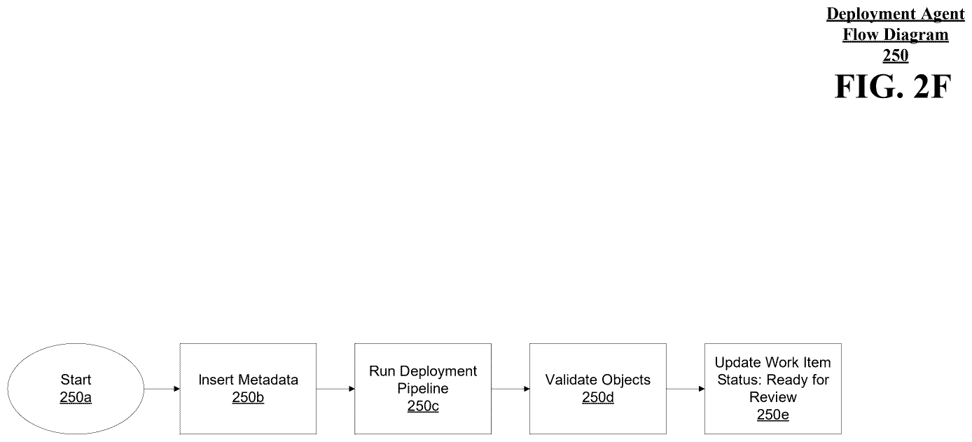

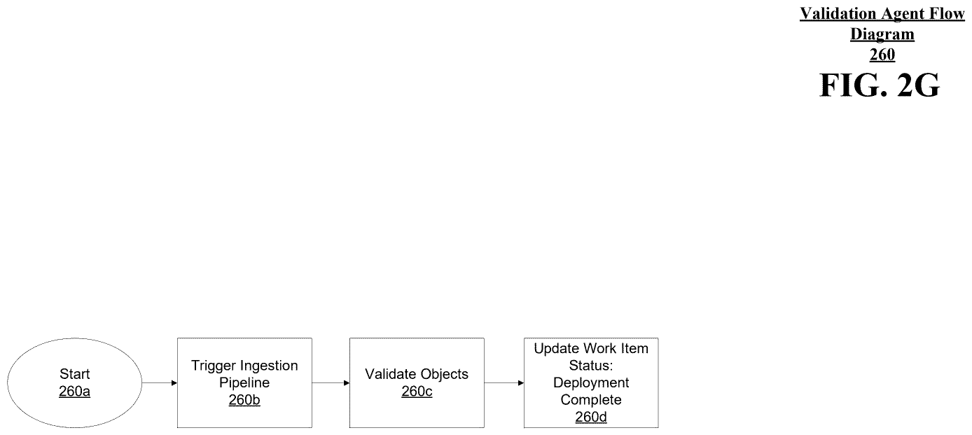

FIG. 1 and FIG. 2A are block diagrams illustrating example, non-limiting embodiments of a system functioning in accordance with various aspects described herein. Referring to FIG. 1, in one or more embodiments, system 100 implements an automated data ingestion and data management process within a multi-agent framework. Further, the system 100 can include a data ingestion server 100a communicatively coupled to a network 100c, facilitating communication with a user computer 100e operated by a user 100f. Additionally, the data ingestion server 100a can be communicatively coupled to network 100d, which facilitates communication with service server 100b.

In one or more embodiments, each of network 100c and network 100d can comprise one or more wireless communication networks, wired communication networks, or a combination thereof. User computer 100e can include, but not be limited to, a desktop computer, a laptop computer, a tablet computer, a mobile device, a mobile phone, a smartphone, or any other computing device. Each of data ingestion server 100a and service server 100b can comprise one or more servers spanning one or more locations, one or more virtual servers spanning one or more locations, one or more cloud servers, or a combination thereof.

In one or more embodiments, the data ingestion server 100a can host multiple agents, each performing specific tasks within the data ingestion and data management process for an (automated) service implemented by service server 100b. Further, the data ingestion server 100a can determine KPIs from a data report generated from the data ingestion and data management process and adjust the service provided by service server 100b to improve the service according to the KPIs. In addition, the data ingestion server 100a can leverage AI-driven decision-making tools and LLMs for tasks as part of the data ingestion and data management process. Also, it can integrate a workflow for real-time monitoring and adaptability, thereby automating the data ingestion and data management process, reducing human intervention, and enhancing data management efficiency and accuracy. Moreover, the service server 100b can implement one or more services that can include, but are not limited to, including loan origination, fraud detection and prevention, customer relationship management, risk management, regulatory compliance, investment portfolio management, financial reporting, and payment processing.

Referring to FIG. 2A, in one or more embodiments, the multi-agent framework 200, which is implemented by the data ingestion server 100a, comprises multiple agents to facilitate the data ingestion and data management process. An agent is or otherwise includes one or more software applications, implemented by a processing system including one or more processors, that is an autonomous computational entity designed to perform specific tasks or functions within the larger multi-agent framework for data ingestion and data management. An agent can operate independently but is also capable of interacting and collaborating with other agents to achieve a common objective (e.g. data ingestion and data management). Each agent can be programmed with, or otherwise adhere to, a set of rules and logic that guide its decision-making processes and actions. In the multi-agent framework, the agents can include a product owner agent 200b, information architect agent 200c, data steward agent 200d, technology agent 200e, deployment agent 200f, and a validation agent 200g. This multi-agent framework can automate the data ingestion and management process through these interconnected agents, each responsible for distinct tasks.

In one or more embodiments, the product owner agent 200b initiates the data ingestion and data management process by creating a requirements document that includes data elements. Further, the product owner agent 200b performs a data glossary items lookup to ensure that data elements conform to organizational standards, updating the requirements document with corresponding glossary IDs or requesting new data glossary items, if necessary.

In one or more embodiments, the information architect agent 200c continues the data ingestion and data management process by generating unique data glossary IDs for new data glossary items, applying standardization logic, and designing a data model that accurately represents the data ingestion process. The information architect agent 200c also validates existing data glossary items for accuracy and consistency.

In one or more embodiments, the data steward agent 200d conducts a sanity check on the requirements document, verifying the application of data quality rules and notifying the product owner agent 200b of any discrepancies. This ensures that the requirements document is complete and accurate before continuing with the data ingestion and data management process.

In one or more embodiments, the technology agent 200e checks connectivity to the data source, creates metadata, and generates data definition language (DDL) scripts for database tables. The technology agent 200e also performs code check-in and can raise a connection request if connectivity issues arise.

In one or more embodiments, the deployment agent 200f inserts metadata and runs a deployment pipeline to create and validate database objects, ensuring they meet the required standards.

In one or more embodiments, the validation agents 200g triggers an ingestion pipeline to load data from the source into a data lake, validating the ingested data against the requirement document. Upon successful validation, the work item is marked as completed.

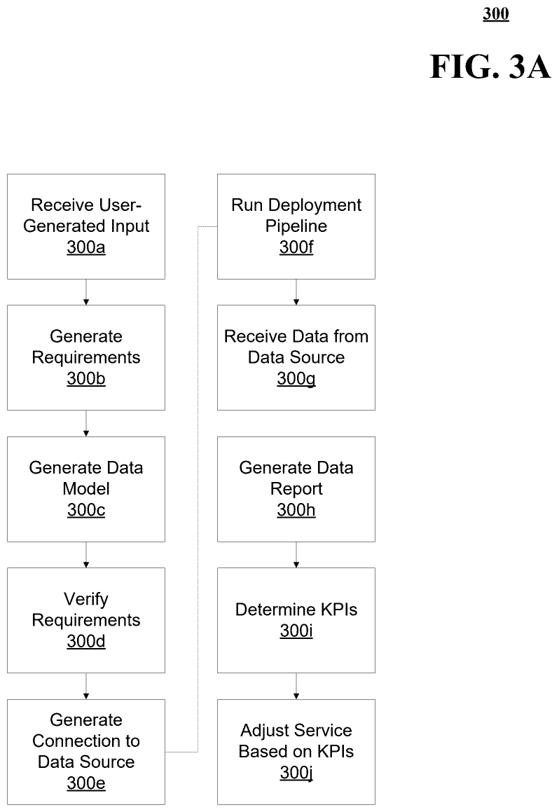

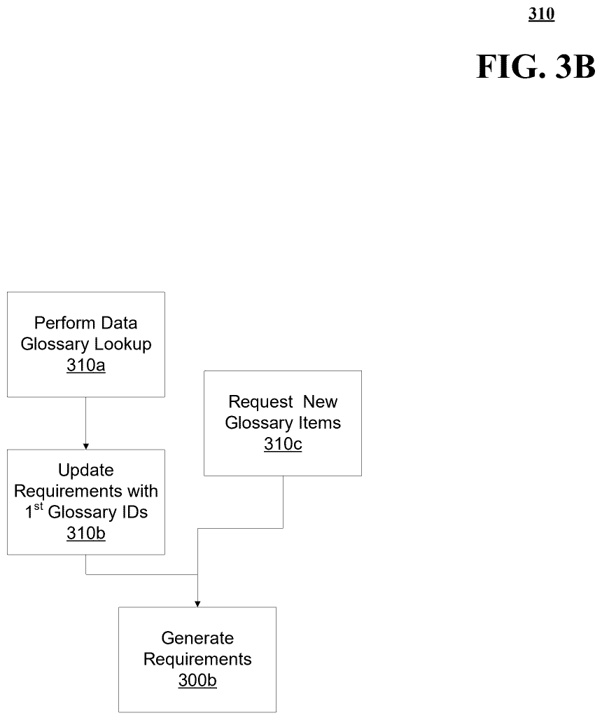

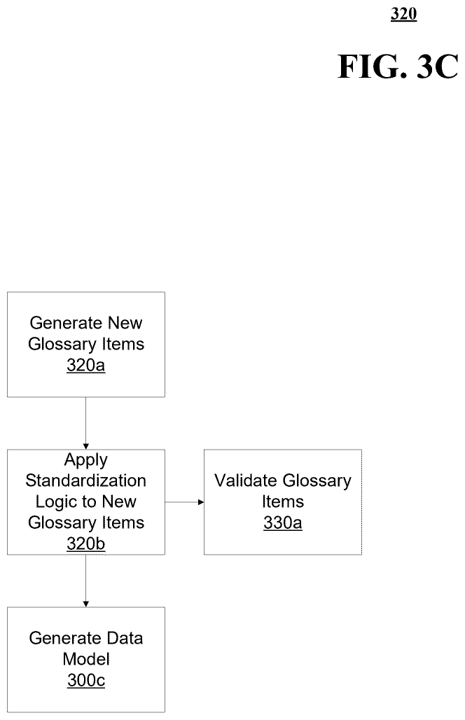

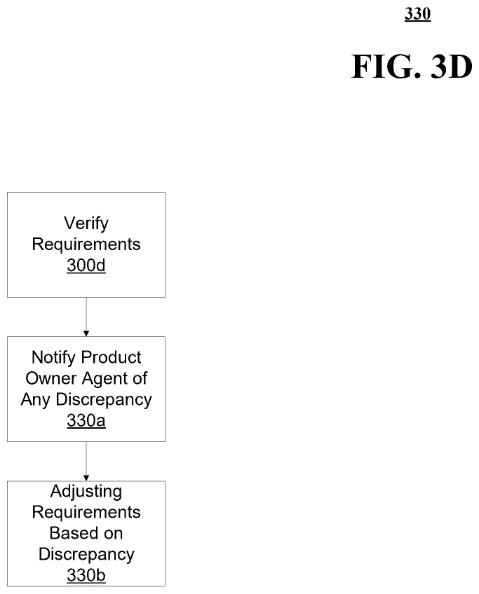

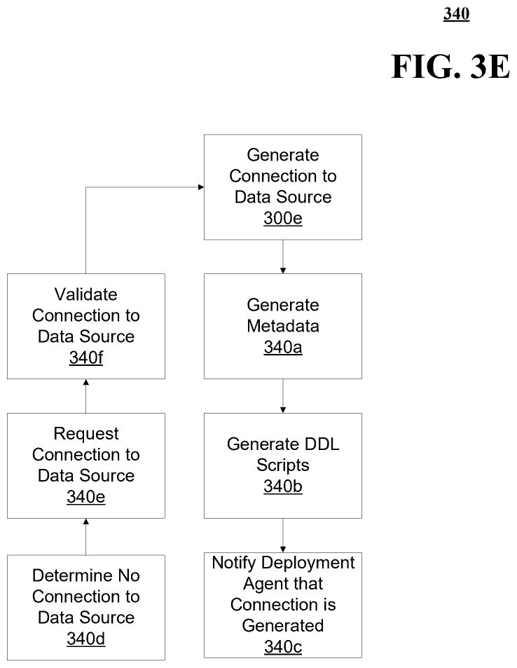

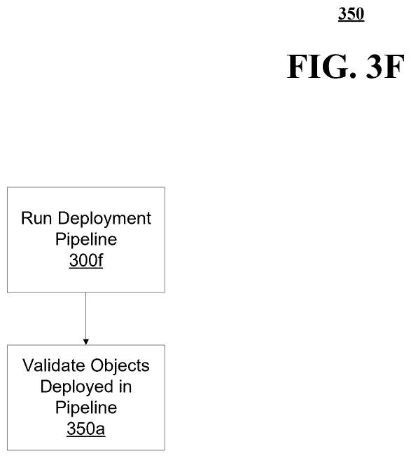

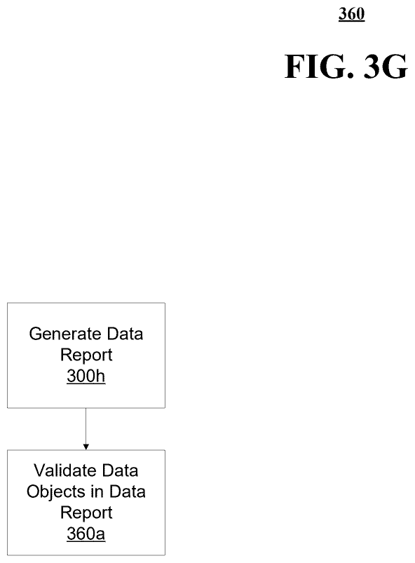

Details of the processes implemented by each agent are discussed in the descriptions of FIGS. 2B-2G as well as in the descriptions of FIGS. 3A-3G.

In one or more embodiments, the multi-agent framework 200 also includes a tool handler 200i, which interacts with various tools such as the requirements document handler 200j, workflow item handler 200k, ID mapping tool 200l, and metadata generator 200m. The requirements document handler 200j is integral to maintaining the integrity and accuracy of the requirement documents, supporting the agents to do so. A work item is a unit of work or task that is tracked and managed within a project management software application. It represents a specific piece of work that needs to be completed as part of a larger project. Work items are used to organize, prioritize, and track progress on tasks, ensuring that teams can efficiently manage their workload and deliver value incrementally. In the multi-agent framework 200 work items are used to track the progress of tasks related to the data ingestion and management process. As the process progresses, the status of the work item is updated to reflect the completion of various stages. These updates provide transparency and accountability, allowing team members to monitor the progress of the task and ensure that it aligns with the project's objectives. Work items facilitate efficient collaboration and communication among team members, aligning with the principles of agile project management to deliver high-quality results in a timely manner. The workflow item handler 200k, accessible via tool handler 200i, can be used by each agent to update the status of a work item associated with the data ingestion and data management process. The ID mapping tool 200l, accessible via tool handler 200i, can be used by one or more agents to manage and map identifiers across various data elements and processes. The metadata generator 200m supports the creation and management of metadata throughout the data ingestion and management process. This tool is accessed through the tool handler 200i and is utilized by different agents.

These tools support the agents in executing their tasks efficiently and effectively. Details of each of the tools 200n utilized by each agent are discussed in the descriptions of FIGS. 2B-2G.

FIGS. 2B-2G and FIGS. 3A-3G depict illustrative embodiments of methods in accordance with various aspects described herein. Referring to FIG. 2B, in one or more embodiments, method 210 is implemented by the product owner agent 200b within the multi-agent framework 200. After initiating the method 210, at 210a, the method can include the product owner agent 200b, at 210b, creating a requirements document. The requirements document outlines the data elements needed or otherwise utilized for data ingestion for a service. In addition, the method 210 can include the product owner agent 200b, at 210c, creating a work item, which tracks the progress and status of the data ingestion task. Also, the method 210 can include the product owner agent 200b, at 210d, performing a data glossary lookup, to ensure that the data elements conform to organizational standards. This lookup determines whether the required glossary items already exist within the organization's data glossary.

In one or more embodiments, the method 210 can include the product owner agent 200b, at 210e, determining whether the data glossary exists within the data glossary. If the data glossary items exist, the method 210 can include the product owner agent 200b, at 210f, updating requirements document with the corresponding data glossary IDs. Further, the method 210 can include the product owner agent 200b, at 210g, updating the work item status to reflect the completion of the architectural assessment. If the glossary items do not exist, the method 210 can include the product owner agent 200b, at 210h, requesting new data glossary items. In addition, the method 210 can include the product owner agent 200 b, at 210i, notifying the information architect agent 200c to generate the necessary glossary IDs and apply standardization logic. This notification ensures that the data model accurately reflects the data ingestion process and adheres to organizational standards.

In one or more embodiments, data elements are fundamental units of data that are used in databases, data management systems, and various applications. They represent specific pieces of information and are often defined by attributes such as name, type, format, and description. Some examples of data elements can include: Customer ID (a unique identifier assigned to each customer in a database-typically an alphanumeric code used to distinguish one customer from another); Name (the given name of an individual, often used in customer or employee records-typically a text string); Email Address (a string representing a user's electronic mail address, used for communication and identification purposes); Phone Number (numeric string representing a contact number, often formatted according to regional standards); Date of Birth (A data element representing an individual's birth date, typically formatted as MM/DD/YYYY or DD/MM/YYYY); Account Balance (a numeric value representing the amount of money in a financial account, often associated with currency and decimal precision); Transaction Date (the date on which a financial transaction occurred, used in banking and financial records); Product Code (a unique identifier for a product, often used in inventory management and sales systems); Order Quantity (a numeric value indicating the number of units ordered for a particular product). These examples illustrate the variety of data elements that can be used across different domains and applications. Each data element is defined by specific attributes that ensure its proper use and interpretation within a system.

In one or more embodiments, a data glossary item can be a defined term or entry within a data glossary, which serves as a centralized repository of standardized definitions and descriptions for data elements used within an organization. Each data glossary item provides a clear and consistent explanation of a specific data element, including its meaning, purpose, and any relevant attributes or metadata. The purpose of a data glossary item is to ensure that all stakeholders within an organization have a common understanding of the data being used, thereby promoting data consistency, accuracy, and governance. By providing standardized definitions, data glossary items help reduce ambiguity and misinterpretation, facilitating effective communication and collaboration across different teams and departments.

In one or more embodiments, data glossary items can be used to ensure that data elements conform to organizational standards. They may include information such as the data element's name, description, format, source, and any associated business rules or constraints. This standardization is crucial for maintaining data quality and integrity across various applications and processes. Examples of data glossary items for example data elements can be as follows. A customer ID data element may have a data glossary items such as a definition (a unique alphanumeric identifier assigned to each customer in the database, attributes (String, 10 characters, unique), and purpose (used to uniquely identify and track customer records). An email address data element may have data glossary items such as a definition (a string representing a user's electronic mail address), attributes (string, should contain “@” and a domain), and purpose (used for communication and identification purposes). A date of birth data element may have data glossary items such as definition (the date representing an individual's birth), attributes (date, formatted as MM/DD/YYYY), purpose (used for age verification and demographic analysis). An account balance data element may have data glossary items such as definition (the current amount of money in a customer's financial account), attributes (decimal, two decimal places, currency format), and purpose (used to display the available funds in an account). A transaction date data element may have data glossary items such as definition (the date on which a financial transaction occurred), attributes (sate, formatted as MM/DD/YYYY), and purpose (used for record-keeping and financial reporting). A product code data element may have data glossary items such as definition (a unique identifier for a product in the inventory system), attributes (string, 8 characters, alphanumeric), and purpose (used to track and manage product inventory, An order quantity data element can have data glossary items such as definition (the number of units ordered for a particular product), attributes (integer, positive value), and purpose (used to process and fulfill customer orders). A phone number data element may have data glossary items such as definition (a numeric string representing a contact number), attributes (string, formatted according to regional standards), and purpose (used for customer contact and communication). These examples demonstrate how data glossary items provide detailed definitions, attributes, etc. for data elements, ensuring that all stakeholders have a consistent understanding of the data being used within an organization.

In one or more embodiments, LLMs are employed utilizing AI/ML software application(s) during the data glossary lookup to intelligently search and match the data elements in the requirements document against the existing entries in the organization's data glossary. The LLMs utilize AI/ML techniques to determine the context and semantics of the data elements, enabling them to perform more accurate and efficient lookups. By utilizing LLMs in data glossary lookup, it ensures that data elements are accurately identified and standardized, reducing the potential for errors and enhancing the overall data management process.

In one or more embodiments, the requirements document handler 200j is utilized by the product owner agent 200b. The requirements document handler 200j, accessible by the tool handler 200i, facilitates creating of the requirements document by providing the necessary templates, guidelines, and validation checks to ensure that the requirements document is comprehensive and adheres to organizational standards. The requirements document handler 200j also assists in updating the requirements document following the data glossary lookup, ensuring that any changes or additions are accurately reflected.

In one or more embodiments, the workflow Item handler 200k can be utilized by the product owner agent via the tool handler 200i during the initial stages of the process. At 210c, the product owner agent 200b creates a work item to document the requirements for data ingestion. The workflow item handler 200k facilitates this task by providing the necessary tools to create, update, and manage the work item, ensuring that it accurately reflects the task's details and status. As the process progresses, the work item status is updated, at 210g, to reflect the completion of the architectural assessment, with the workflow item handler 200k ensuring that these updates are recorded and tracked efficiently.

In one or more embodiments, the ID mapping tool 200l, accessible via tool handler 200i, is used when creating the requirements document and performing the data glossary lookup. It helps in associating data elements with their corresponding glossary IDs, ensuring that each element is accurately identified and mapped according to organizational standards. If new glossary items are needed, the ID mapping tool 200l assists in generating and mapping new IDs as part of the new data glossary request.

Referring to FIG. 2C, in one or more embodiments, method 220 is implemented by the information architect agent 200c within the multi-agent framework. After initiating the method 220, at 220a, in response to a request from the product owner agent 200b, method 220 has two flows. One flow can comprise creating a new data glossary item and another flow can comprise validating data glossary items. Further, the method 220 can include the information architect agent 200c, at 220b, creating new data glossary items, which can be necessary when existing glossary entries do not cover the required data elements. Further, the method 220 can include the information architect agent 200c, at 220d, applying standardization logic to the newly created data glossary item to maintain consistency across the data model. In addition, the method 220 can include the information architect agent 200c, at 220f, designing the data model, which accurately represents the data ingestion and data management process and incorporates the standardized glossary items. This data model serves as a blueprint for subsequent data management tasks. Also, the method 220 can include the information architect agent 200c, at 220g, updating the workflow item to a status of “Under Refinement.” Further, the method 220 can include the information architect agent 200 c, at 220i, notifying the data steward agent 200d, to proceed with the next phase of the data ingestion and data management process implemented by the data steward agent 200d.

In one or more embodiments, the method 220 can include the information architect agent 200c, at 220c, validating existing data glossary items ensuring that they meet organizational standards and are accurate. Further, the method 220 can include the information architect agent, at 220e, determining whether the existing data glossary items are approved in the data catalog (as part of validating the existing data glossary items). If so, the method 220 can include the information architect agent 200 c, at 220i, notifying the data steward agent 200d, to proceed with the next phase of the data ingestion lifecycle implemented by the data steward agent 200d. If not, the method 220 can include the information architect agent 200c, at 220h, recalling the product owner agent 200b to adjust the requirements document to be associated with existing data glossary items that are approved by the data catalog. A data catalog is a centralized repository that serves as a comprehensive inventory of data resources, providing detailed information about data elements, their definitions, relationships, and usage.

In one or more embodiments, data glossary IDs serve as unique identifiers for data glossary items within an organization's data glossary, ensuring consistent referencing and management of data elements across various systems and processes. For example, the ID “CUST_ID_001” might be assigned to the data glossary item “Customer ID,” which is defined as a unique alphanumeric identifier for each customer in the database. Similarly, “EMAIL_ADDR_002” could refer to the “Email Address” item, described as a string representing a user's electronic mail address. In another example is “DOB_003,” which corresponds to the “Date of Birth” glossary item, defined as the date representing an individual's birth. The ID “ACC_BAL_004” might be used for “Account Balance,” indicating the current amount of money in a customer's financial account. For transaction-related data, “TRANS_DATE_005” can identify the “Transaction Date” data glossary item, which is the date on which a financial transaction occurred. In product management, “PROD_CODE_006” can be assigned to the “Product Code” item, a unique identifier for a product in the inventory system. For order processing, “ORDER_QTY_007” could refer to the “Order Quantity” item, representing the number of units ordered for a particular product. In addition, “PHONE_NUM_008” might be used for the “Phone Number” item, a numeric string representing a contact number. These examples illustrate how data glossary IDs are utilized to uniquely identify and reference data glossary items, facilitating consistent data management and communication throughout an organization.

In one or more embodiments, standardization logic refers to the application of a set of rules and procedures to data elements to ensure they are consistent, uniform, and adhere to predefined standards across an organization. This logic maintains data quality and integrity, as it helps eliminate discrepancies and variations in data representation, making it easier to manage, analyze, and share data across different systems and teams. For example, standardization logic might dictate that all date fields within an organization follow a consistent format, such as MM/DD/YYYY. This uniformity prevents confusion and errors when dates are used in calculations or comparisons. Similarly, naming conventions can be standardized, ensuring that data elements like “Customer ID” are consistently referred to as “CustID” across all databases and applications, facilitating easy identification and reference. Further, standardization logic can apply to data types. For example, all text fields might be standardized to the “String” data type, while currency values are represented as “Decimal.” This ensures compatibility and accuracy in data processing. Additionally, units of measurement can be standardized, such as using meters for length or kilograms for weight, to enable accurate data analysis and reporting. In addition, standardization logic can be applied to address formatting, where a consistent format is applied to elements like street, city, state, and postal code, ensuring uniformity in data entry and retrieval. Similarly, currency representation can be standardized by using a specific currency symbol and decimal places, maintaining consistency in financial data. Phone numbers can also be standardized to include country and area codes, facilitating accurate communication and data validation. By implementing standardization logic, organizations can achieve greater data consistency, reduce errors, and enhance the overall quality and usability of their data assets. This is particularly important in environments where data is shared and integrated across multiple systems, teams, jurisdictions, countries, and so forth.

In one or more embodiments, applying standardization logic can include the use of LLMs utilizing an AI/ML software application to enhance the efficiency and accuracy of standardizing data glossary items. The LLMs can utilize AI/ML techniques to understand the context and semantics of the data elements, enabling them to apply consistent formats, naming conventions, and data types across the glossary items. This ensures that the data elements adhere to predefined organizational standards, facilitating uniformity and consistency in data representation. By using LLMs, it can intelligently determine the appropriate standardization rules for each data element, reducing the potential for human error and enhancing the overall data management process. The application of standardization logic through LLMs helps streamline the data management process, allowing for more efficient and reliable integration of data elements into the organization's systems. This automation not only improves the accuracy of the standardization process but also frees up human resources to focus on more complex tasks.

In one or more embodiments, a data model is a conceptual framework that defines how data is structured, stored, and accessed within a database or information repository system. It provides a systematic way to organize and represent data elements and their relationships, ensuring consistency and clarity in data management. A data model serves as a blueprint for designing databases as well as information repositories to understand the data requirements of an organization. One example of a data model can be a hierarchical data model that organizes data in a tree-like structure, where each record has a single parent and potentially many children. This model is used in applications where data has a clear hierarchical relationship, such as organizational charts or file systems. Another example of a data model can be a network data model that allows for more complex relationships by permitting multiple parent records for each child. This data model is suitable for applications like telecommunications and transportation networks, where data relationships are more interconnected. A further example of a data model can be a relational data model that organizes data into tables, known as relations, with rows and columns. Each table represents an entity, and relationships between tables are established through keys. An additional example of a data model can be an object-oriented data model that represents data as objects, similar to object-oriented programming. It is used in applications that require complex data representations. Another example of a data model can be an entity-relationship (ER) model that uses entities, attributes, and relationships to represent data. It is often employed in the design phase of database development to visually map out the data structure and relationships before implementation. A further example of a data model can be a document data model that stores data in document formats like JSON or XML. This data model is suitable for applications that require flexible and dynamic data structures, such as content management systems and web applications. These examples illustrate the various data models, each suited to different types of data and application requirements. By selecting the appropriate data model, organizations can effectively manage and utilize their data resources. In some embodiments, the data ingestion server 100a can determine its data resources (e.g., memory capacity) and select a data model according to available data resources to efficient utilize them accordingly.

In one or more embodiments, LLMs implemented by an AI/ML software application can assist in designing a data model in enhancing the process by utilizing AI/ML techniques. The LLMs analyze the standardized glossary items and understand the relationships and dependencies between different data elements. They use this information to generate a coherent and optimized data model that accurately represents the data ingestion and data management process. The LLMs can identify patterns and suggest the most efficient ways to structure the data, ensuring that the model is both comprehensive and adaptable to future changes. By incorporating LLMs in the design of the data model, the framework benefits from enhanced accuracy, reduced manual effort, and the ability to adapt to evolving data requirements, ultimately leading to more efficient data management and utilization.

In one or more embodiments, the workflow item handler is utilized by the information architect agent 200c, accessible via the tool handler 200i, to update the work item status to an “Under Refinement” status. This update reflects the progress made in the task and ensures that the work item accurately represents the current state of the data ingestion process.

In one or more embodiments, the information architect agent 200c relies on the ID mapping tool 200l, accessible via tool handler 200i, when creating new glossary items and applying standardization logic. The ID mapping tool 200l facilitates the generation of unique IDs for new glossary items and ensures that these IDs are consistently applied across the data model. This ensures that all data elements are properly mapped and standardized, maintaining consistency and accuracy in the data management process.

Referring to FIG. 2D, in one or more embodiments, aspects of method 230 can be implemented by the data steward agent 200d. After initiating the method 230, at 230a, the method 230 can include the data steward agent 200d, at 230b, determining whether the data fields associated with the data ingestion lifecycle are verified. This verification ensures that all necessary data quality rules are applied and that the requirements document is complete and accurate. If the data fields are not verified, the method 230 can include the data steward agent 200d, at 230d, recalling the product owner agent 200b to adjust the requirements document such that the data fields can be verified. If data fields are verified, the method 230 can include the data steward agent 200d, at 230c, updating the work item to a status of “Ready.” This status update signifies that the requirement document has passed the necessary checks and is prepared for the next phase of the data ingestion and data management process. Further, the method 230 can include the data steward agent 200d, at 230e, notifying the technology agent 200e to proceed with the subsequent tasks in the data ingestion and data management process.

In one or more embodiments, data quality rules are specific criteria or guidelines designed to ensure the accuracy, consistency, completeness, and reliability of data within an organization. These rules maintain data quality standards, which provide effective decision-making and operational efficiency. By applying data quality rules, organizations can identify and rectify errors, inconsistencies, and anomalies in their data, ensuring that it meets the necessary requirements and standards. For example, in a customer database, data quality rules might include a uniqueness rule that ensures each Customer ID is unique across the database, preventing duplicate entries. This rule helps maintain the integrity of customer records by ensuring that each customer is represented only once. Another rule might be a format rule that validates email addresses to ensure they follow a standard format, such as containing an “@” symbol and a valid domain, which is essential for communication purposes. Additionally, a range rule might check that account balances are non-negative, ensuring that no account has a negative balance, thereby maintaining financial accuracy and preventing erroneous data entries. A completeness rule could require that all mandatory fields, such as First Name, Last Name, and Date of Birth, are filled out for each customer record, ensuring that essential information is not missing from the database. Further, a consistency rule might ensure that the Date of Birth field is consistent with the Age field, verifying that the age calculated from the date of birth matches the recorded age, thus maintaining logical consistency within the data. By implementing data quality rules, organizations can ensure that their data is accurate, reliable, and fit for its intended purpose, thereby enhancing the overall quality and usability of their data assets.

In one or more embodiments, the workflow item handler 200k, accessible via the tool handler 200i, facilitates the update of the work item status to “Ready.” This update reflects that the requirement document has passed the necessary checks and is prepared for the next phase of the data ingestion process.

Referring to FIG. 2E, in one or more embodiments, aspects of method 240 are implemented by the technology agent 200e. After initiating, at 240a, the method 240 can include the technology agent 200e, at 240b, determining whether there is connectivity to the data source. If not, the method 240 can include the technology agent 200e, at 240c, raising a connection request to establish the necessary link to the data source. In addition, the method 240 can include the technology agent 200e, at 240d, validating the connectivity to the data source and restarting the technology agent 200e to reinitiate the method 240 from its beginning.

In one or more embodiments, if there is connectivity to the data source, the method 240 can include the technology agent 200e, at 240e, creating metadata necessary for the data ingestion process. Further, the method 240 can include the technology agent 200e, at 240f, creating data definition language (DDL) scripts for the database tables. DDL scripts define the structure and organization of the data within the database. In addition, the method 240 can include the technology agent 200e, at 240g, performing a code check-in and conducting a peer review to ensure the code meets the required standards and aligns with the requirement document. Also, the method 240 can include the technology agent 200e, at 240h, notifying the deployment agent 200f, with an indication that the necessary preparations for data deployment are complete.

In one or more embodiments, a data source can be any information repository associated with a service from which data is obtained for processing, analysis, or storage. In some embodiments, a data source can be a database, a data warehouse, a cloud storage service, an application, or any other system that holds data relevant to a service. The data source serves as the origin point for data that needs to be ingested, transformed, and managed. One example of a data source can be a relational database, such as MySQL or PostgreSQL, which stores data in structured tables with rows and columns. These databases are commonly used for transactional data and are accessed using SQL queries. Another example can be a data warehouse, which serves as a centralized repository for storing large volumes of structured data from multiple sources. Data warehouses are optimized for query and analysis rather than transaction processing. A further example of a data source can be NoSQL databases. These databases are designed to handle unstructured or semi-structured data and are often used in big data applications due to their scalability and flexibility. Cloud storage services provide scalable solutions for storing both structured and unstructured data, making them ideal for integrating with cloud-based analytics tools. Other examples of data sources can include APIs and web services by allowing applications to access data from external systems or services. They can provide real-time data from various platforms, such as social media or financial services. Additional examples of data sources can be flat files, such as CSV or JSON files, which are simple data files that store data in a structured format and are often used for data exchange between systems. A further example of a data source can be data lakes, which are storage repositories that hold vast amounts of raw data in its native format, are used to store structured, semi-structured, and unstructured data. They are particularly useful in big data analytics, allowing organizations to store data until it is needed for processing. These examples illustrate the variety of data sources that can be integrated into a multi-agent framework, each offering unique advantages for data management and analysis. Connection to such data sources can be established over one or more communication networks via applications and/or application programming interfaces (APIs).

In one or more embodiments, metadata refers to the descriptive information about the data being ingested, which provides context and meaning to the raw data. Metadata includes details such as the structure, format, and attributes of the data, as well as information about its origin, usage, and relationships with other data elements. It serves as a guide for understanding and managing the data. For example, metadata can include the names and types of data fields, the data source from which the data is obtained, the date and time of data collection, and any transformations applied to the data. It can also include data quality metrics, access permissions, and lineage information that tracks the data's journey through various systems and processes. Metadata can facilitate data governance, enhance data quality, and supports efficient data management by providing a comprehensive understanding of the data's characteristics and context.

In one or more embodiments, creating of the metadata can include the use of LLMs to utilize an AI/ML software application to enhance the efficiency and accuracy of metadata generation. The LLMs assist in this task by utilizing AI/ML techniques to analyze the data elements and their relationships. They help in automatically generating metadata that accurately describes the structure, format, and attributes of the data. This includes details such as data field names, data types, and any relevant constraints or relationships between data elements. By using LLMs, it can intelligently determine the appropriate metadata for each data element, ensuring that it adheres to organizational standards and is consistent across different systems. This automation reduces the potential for human error and enhances the overall data management process by providing a comprehensive and accurate representation of the data.

In one or more embodiments, Data Definition Language (DDL) scripts can be a set of SQL commands used to define and manage the structure of a database. These scripts are used for creating and modifying the schema of a database, which includes the tables, indexes, views, and other database objects. DDL scripts do not manipulate the data within the tables but rather focus on the structure and organization of the database itself. Further, DDL scripts can create tables with specified columns and data types, defining primary and foreign keys to establish relationships between tables, and setting up indexes to optimize query performance. The creation of DDL scripts ensures that the database is properly configured to handle the incoming data and support efficient data management and retrieval. By automating the generation of DDL scripts, it ensures that the database schema is consistently and accurately defined, reducing the potential for errors and enhancing the overall efficiency of the data ingestion process.

In one or more embodiments, foreign keys are a concept in relational databases, used to establish and enforce relationships between tables. A foreign key is a column or a set of columns in one table that references the primary key of another table. This relationship ensures referential integrity, meaning that the data in the foreign key column must match a valid primary key value in the referenced table. For example, consider a database with two tables: Orders and Customers. The Customers table has a primary key column called CustomerID, which uniquely identifies each customer. The Orders table might have a column also named CustomerID, which serves as a foreign key. This foreign key establishes a link between each order and the customer who placed it, ensuring that every order is associated with a valid customer in the Customers table.

In one or more embodiments, the process of creating DDL scripts includes the use of LLMs to enhance the efficiency and accuracy of script generation. The LLMs assist in this task by utilizing AI/ML techniques to analyze the metadata and data elements that have been previously defined. They help in automatically generating DDL scripts that accurately specify the creation of database objects such as tables, indexes, and constraints. This includes defining the data types, primary keys, foreign keys, and any other necessary attributes that ensure the database schema is robust and aligned with organizational standards. By using LLMs, it can intelligently determine the appropriate structure for the database objects, reducing the potential for human error and enhancing the overall data management process. This automation not only improves the accuracy of the DDL scripts but also accelerates the deployment process by ensuring that the database is properly configured to handle the incoming data.

In one or more embodiments, a code check-in is a process in software development where changes made to the source code are submitted to a version control system. This process involves saving the updated code to a central repository, where it becomes part of the project's codebase. The purpose of a code check-in is to ensure that all team members have access to the latest version of the code and to maintain a history of changes for tracking and collaboration purposes.

In one or more embodiments, the technology agent 200e utilizes the metadata generator 200m, accessible via the tool handler 200i, to create metadata once source connectivity is confirmed. This step is for defining the structure, format, and attributes of the data, providing a comprehensive understanding of the data's characteristics and context.

Referring to FIG. 2F, in one or more embodiments, aspects of method 250 are implemented by the deployment agent 200f. After initiating the method 250, at 250a, the method 250 can include the deployment agent 200f, at 250b, inserting metadata into a lower environment, as indicated by node 250b. This sets up the necessary data structures and configurations required for the deployment process. In addition, the method 250 can include the deployment agent 200f, at 250c, running the deployment pipeline. The deployment pipeline is responsible for creating and validating the database objects, ensuring they meet the required standards and specifications outlined in the requirements document. Also, the method 250 can include the deployment agent 200f, at 250d, validating the deployed objects. This validation confirms that the objects have been correctly created and are functioning as intended within the data environment. Further, the method 250 can include the deployment agent 200 f, at 250e, updating the work item status to “Ready for Review.” This status update signifies that the deployment is complete and ready for evaluation by other agents or stakeholders involved in the data ingestion lifecycle.

In one or more embodiments, a deployment pipeline is a structured sequence of automated processes that facilitate the deployment of software or data components from development through to production environments. It encompasses various stages, such as building, testing, and deploying, ensuring that each component is correctly integrated and functioning as intended before it reaches the end users. Further, deploying the pipeline in the data ingestion and data management process involves executing a series of automated tasks that prepare the data or software for deployment, including compiling code, running tests, and packaging the components. The pipeline ensures that all necessary steps are completed in a consistent and repeatable manner, reducing the risk of errors and enhancing the reliability of the deployment process.

In one or more embodiments, inserting metadata into lower environments refers to the process of deploying metadata into non-production environments, such as development, testing, or staging environments, before it is moved to the production environment. Metadata, in this context, includes the descriptive information about the data structures, such as table definitions, data types, relationships, and constraints, which are necessary for the data management system to understand and process the data correctly. By inserting metadata into lower environments, organizations can test and validate the data structures and configurations in a controlled setting. This step can identify and resolve any issues or inconsistencies before the data and its associated metadata are deployed to the production environment, where they will be used in live operations. This practice helps ensure that the data management processes are robust, reliable, and free from errors, ultimately supporting the integrity and efficiency of the overall data ingestion and management process.

In one or more embodiments, validation of data objects comprises verifying that the database objects created during the deployment pipeline are correctly implemented and meet the required standards and specifications. This validation ensures that the objects, such as tables, indexes, and views, are functioning as intended within the data environment.

In one or more embodiment, the workflow item handler 200k is utilized by the deployment agent 200f. The workflow item handler facilitates the update of the work item status to “Ready for Review.” This update reflects that the deployment process has been successfully completed and that the deployed objects are ready for evaluation by other agents or stakeholders involved in the data ingestion and data management process.

Referring to FIG. 2G, in one or more embodiments, aspects of method 260 are implemented by validation agent 200g. After initiating, at 260a, the method 260 can include the validation agent 200g, at 260b, triggering the ingestion pipeline. This step loads data from the source into the data lake, ensuring that the data is available for further processing and analysis. In addition, the method 260 can include the validation agent 200g, at 260c, validating the ingested objects. This validation step ensures that the data aligns with the requirements specified in the requirements document and meets the necessary quality standards. Also, the method 260 can include the validation agent 200g, at 260d, updating the work item to a deployment complete status. This status update signifies that the validation process is complete and that all tasks have been successfully executed, marking the end of the data ingestion and management deployment.

In one or more embodiments, triggering the ingestion pipeline refers to the process of initiating the automated sequence that loads data from a specified source into the data lake or another target storage system. It marks the beginning of data movement from its origin to the destination where it will be stored, processed, and analyzed. The ingestion pipeline is typically designed to handle various data formats and sources, ensuring that data is collected efficiently and accurately. By triggering this pipeline, the system activates a series of predefined operations that may include data extraction, transformation, and loading (ETL) tasks. These operations ensure that the data is properly formatted, cleansed, and integrated into the target system, ready for further validation and use.

In one or more embodiments validation objects in method 260 involve checking the data objects that have been ingested into the data lake to ensure they conform to the requirements specified in the requirements document. It includes validating the accuracy and integrity of the ingested data, ensuring it meets the necessary quality standards and is ready for use in subsequent processes. Note, in method 250, validation is concerned with the structural integrity and correctness of the database objects created during deployment, while in method 260, validation is focused on the data itself, ensuring that the ingested data is accurate and consistent with the defined specifications.

In one or more embodiments, the requirements document handler 200j, accessible via the tool handler 200i, plays a role in the validation process conducted by the validation agent 200g. After the ingestion pipeline is triggered, the validation agent 200g performs a series of validation checks on the ingested data objects. The requirements document handler 200j provides the reference framework against which these validations are conducted, ensuring that the data aligns with the specifications outlined in the requirement document. This ensures that the data meets the necessary quality standards.

In one or more embodiments, the workflow item handler 200k, accessible via tool handler 200i, is utilized by the validation agent 200g. The workflow item handler 200k facilitates the update of the work item status to “Deployment Complete.” This update signifies that the validation process is complete and that all tasks have been successfully executed, marking the end of the data ingestion and management deployment.

Referring back to FIG. 1, in one or more embodiments, once a data report is generated, the data ingestion server 100a analyzes the data report to extract relevant metrics for evaluating the performance of a service. The generated data report can be formatted in various ways to suit different analytical and reporting needs. One example format is the tabular format, where data is organized into rows and columns. Each row represents a record, and each column represents a data attribute or field. This format is particularly useful for displaying structured data and is easily exportable to spreadsheets or databases for further analysis. Another example format is a graphical format, which includes visual elements such as charts, graphs, and dashboards. These visualizations help in quickly conveying insights and trends, making it easier for stakeholders to understand complex data sets. Common types of visualizations include bar charts, line graphs, pie charts, and scatter plots. A further example format can be a summary format provides a high-level overview of the data, highlighting key metrics and insights. This format is useful for executive summaries or presentations where detailed data is not required, but key findings and trends need to be communicated effectively. An additional example format can be a narrative format, which combines quantitative data with qualitative analysis. This format provides context and insights that help explain the significance of the data, offering a more comprehensive understanding of the results. Moreover, a data report can also be interactive, allowing users to explore the data dynamically. Interactive reports may include features such as drill-down capabilities, filters, and clickable elements that enable users to customize their view and analysis of the data. Some other example formats can include PDF documents or word processing files. This format ensures that the report is easily shareable and can be printed or stored for future reference. These exemplary formats can be used individually or in combination, depending on the audience and the specific requirements of the data report. The choice of format will depend on factors such as the complexity of the data, the intended use of the report, and the preferences of the stakeholders involved.

In one or more embodiments, the KPIs are determined by identifying specific data points and trends within the data report that align with the organization's strategic goals and objectives. These indicators provide measurable values that reflect the effectiveness, efficiency, and success of the service being analyzed.

In one or more embodiments, in a loan origination service, KPIs can include the approval rate, processing time, and default rate. The approval rate measures the percentage of loan applications that are approved out of the total received, providing insight into the efficiency and criteria of the approval process. Processing time tracks the average duration from the submission of a loan application to its approval or rejection, highlighting the speed and efficiency of the process. The default rate indicates the percentage of loans that default within a specified period after origination, offering a measure of the risk associated with the loans issued.

In one or more embodiments, for a loan origination service implemented by the service server 100b, the data ingestion server 100a can provide instructions to the service server 100b to adjust KPIs such as the approval rate, processing time, and default rate (all of which can be automated by service server 100b) which can significantly enhance the service. By analyzing the approval rate, the data ingestion server 100a can automatically adjust the service criteria to ensure that more applications are approved without compromising risk management. Further, the instructions can reduce processing time by streamlining workflows through automation to expedite the evaluation and decision-making process, thereby improving customer satisfaction and operational efficiency. In addition, the instructions can adjust automatically the credit risk models based on borrower profiles to improve the default rate. Moreover, adjusting the loan origination service can comprise adjusting (automatically) one or more KPI thresholds associated with the loan origination (automated) service.

In one or more embodiments, in a fraud detection and prevention service, KPIs can include the detection rate, false positive rate, and response time. The detection rate measures the percentage of fraudulent activities successfully identified and flagged by the system, reflecting the effectiveness of the fraud detection mechanisms. The false positive rate, however, indicates the percentage of legitimate transactions incorrectly flagged as fraudulent, which can impact customer satisfaction and operational efficiency. Response time measures the average duration taken to respond to and investigate a flagged transaction, providing insight into the agility and responsiveness of the fraud prevention system.

In one or more embodiments, for a fraud detection and prevention service, the data ingestion server 100a can provide the instructions to the service server 100b to adjust the fraud detection and prevention service. Adjusting the service can include enhancing the detection rate by implementing advanced analytics and machine learning algorithms to identify fraudulent patterns more accurately. Further, adjusting the service can include reducing the false positive rate by minimizing the number of legitimate transactions flagged as fraudulent, which can improve customer experience and reduce operational costs. In addition, the adjusting of the service can include automating the improvement of the response time by optimizing the investigation process and ensuring that alerts are prioritized and addressed promptly, thereby enhancing the system's overall effectiveness.

Moreover, adjusting the fraud detection and prevention service can comprise adjusting (automatically) one or more KPI thresholds associated with the fraud detection and prevention service.

In one or more embodiments, in a customer relationship management (CRM) service, KPIs can include the customer satisfaction score, customer retention rate, and average resolution time. The customer satisfaction score is derived from feedback and surveys, offering a direct measure of customer satisfaction with the services provided. The customer retention rate tracks the percentage of customers retained over a specific period, indicating the effectiveness of customer loyalty and retention strategies. Average resolution time measures the average duration taken to resolve customer inquiries or issues, reflecting the efficiency and effectiveness of customer service operations.

In one or more embodiments, adjusting the KPIs by a data ingestion server 100a for a CRM service implemented by a service server 100b can include increasing the customer satisfaction score by gathering and acting on customer feedback to improve service quality and address pain points. Adjusting the service can comprise enhancing the customer retention rate by generating and offering targeted loyalty programs and personalized engagement strategies to foster long-term relationships. Further, adjusting the service can comprise reducing average resolution time involves streamlining support processes and empowering customer service representatives with the tools and information needed to resolve issues quickly and effectively. Moreover, adjusting the CRM service can comprise adjusting (automatically) one or more KPI thresholds associated with the CRM service.

In one or more embodiments, in a risk management service, KPIs can include risk exposure, mitigation success rate, and incident frequency are important. Risk exposure measures the total value of assets or transactions exposed to risk, providing insight into the potential impact of risk events. The mitigation success rate indicates the percentage of identified risks that have been successfully mitigated, reflecting the effectiveness of risk management strategies. Incident frequency tracks the number of risk incidents occurring within a specified timeframe, offering a measure of the prevalence and impact of risk events.

In one or more embodiments, adjusting, by the data ingestion server 100a, the risk management service implemented, by the service server 100b, can include reducing (automatically) risk exposure by diversifying assets and implementing robust risk assessment frameworks to identify and mitigate potential threats. Further, adjusting the service can comprise increasing the mitigation success rate by refining risk management strategies and ensuring that identified risks are addressed promptly and effectively. Further, adjusting the service can include decreasing incident frequency by implementing proactive measures and continuous monitoring to prevent risk events from occurring. Moreover, adjusting the risk management service can comprise adjusting (automatically) one or more KPI thresholds associated with the loan risk management service.

In one or more embodiments, in a regulatory compliance service, KPIs can include the compliance rate, audit findings, and training completion rate are critical. The compliance rate measures the percentage of processes and transactions that comply with regulatory standards, reflecting the effectiveness of compliance efforts. Audit findings indicate the number of issues or non-compliance instances identified during audits, providing insight into areas for improvement. The training completion rate tracks the percentage of employees who have completed required compliance training, highlighting the organization's commitment to compliance and employee education.

In one or more embodiments, in a regulatory compliance service implemented by the service server 100b, the adjusting of the service, by the data ingestion server 100a, can comprise improving the compliance rate by ensuring that all processes and transactions adhere to regulatory standards through regular audits and updates to compliance policies. Further, the adjusting the service can comprise reducing audit findings by addressing identified issues and implementing corrective actions to prevent future occurrences. In addition, the adjusting the service can increase the training completion rate by offering all employees receive the necessary compliance training and are aware of their responsibilities in maintaining regulatory standards. Moreover, adjusting the regulation compliance service can comprise adjusting (automatically) one or more KPI thresholds associated with the regulatory compliance service.

In one or more embodiments, in an investment portfolio management service, KPIs can include return on investment (ROI), portfolio diversification, and risk-adjusted return are essential. ROI measures the percentage gain or loss on investments over a specified period, providing insight into the profitability of investment strategies. Portfolio diversification measures the diversity of assets within the portfolio, reflecting the level of risk management and investment strategy. Risk-adjusted return measures the return on investment adjusted for the level of risk taken, offering a more comprehensive view of investment performance.

In one or more embodiments, adjusting, by the data ingestion server 100a, an investment portfolio management service, implemented by a service server 100b, can include enhancing ROI by optimizing investment strategies and identifying opportunities for growth and profitability. Further, adjusting the service can comprise improving portfolio diversification by automating the balancing of asset classes and sectors to minimize risk and maximize returns. In addition, the adjusting of the service can include increasing the risk-adjusted return by evaluating investment performance relative to the level of risk taken, ensuring that the portfolio is aligned with the organization's risk tolerance and objectives. Moreover, adjusting the investment portfolio management service can comprise adjusting (automatically) one or more KPI thresholds associated with the investment portfolio management service.

In one or more embodiments, in a financial reporting and analysis service, KPIs can include accuracy rate, timeliness, and variance analysis are important. The accuracy rate measures the percentage of financial reports that are accurate and free from errors, reflecting the reliability and quality of financial reporting. Timeliness tracks the average duration taken to prepare and deliver financial reports, highlighting the efficiency of financial reporting processes. Variance analysis measures the difference between projected and actual financial performance, providing insight into areas for improvement and adjustment.

In one or more embodiments, adjusting, by the data ingestion server 100a, a financial reporting and analysis service, by the service server 100b, can comprise increasing the accuracy rate by implementing robust data validation and reconciliation processes to ensure that financial reports are free from errors. Further, the adjusting of the service can comprise improving timeliness by streamlining reporting workflows and automating data collection and analysis. In addition, the adjusting service comprises enhancing variance analysis by identifying and addressing discrepancies between projected and actual performance, providing insights for strategic decision-making and performance improvement. Moreover, adjusting the financial reporting and analysis service can comprise adjusting (automatically) one or more KPI thresholds associated with the financial reporting and analysis service.

In one or more embodiments, in the payment processing service, KPIs can include transaction success rate, processing time, and chargeback rate are crucial. The transaction success rate measures the percentage of transactions processed successfully without errors, reflecting the reliability and efficiency of payment processing systems. Processing time tracks the average duration taken to complete a payment transaction, highlighting the speed and efficiency of payment processing. The chargeback rate measures the percentage of transactions that are disputed and result in chargebacks, offering insight into the effectiveness of fraud prevention and customer satisfaction efforts.

In one or more embodiments, adjusting, by the data ingestion server 100a, a payment processing service, implemented by a service server 100b, can comprise the increasing the transaction success rate involves ensuring that payment systems are reliable and capable of handling transactions efficiently. Further, adjusting the service can comprise reducing processing time by optimizing payment workflows and automating transaction processing. In addition, adjusting the service can comprise decreasing the chargeback rate involves implementing effective fraud prevention measures and ensuring that customer disputes are resolved promptly and satisfactorily. Moreover, adjusting the payment processing service can comprise adjusting (automatically) one or more KPI thresholds associated with the payment processing service.

Referring to FIG. 3A, in one or more embodiments, aspects of method 300 can be implemented by the data ingestion server 100a. The method 300 can include the data ingestion server 100a, at 300a, receiving, by the product owner agent 200b, user-generated input indicating a request for a data report to adjust a service. Further, the method 300 can include the data ingestion server 100a, at 300b, generating, by the product owner agent 200b, a group of requirements associated with generating the data report utilizing an artificial intelligence (AI) software application. In addition, the method 300 can include the data ingestion server 100a, at 300c, generating, by the information architect agent 200c, a data model for generating the data report utilizing the AI software application. Also, the method 300 can include the data ingestion server 100a, at 300d, verifying, by the data steward agent 200d, the group of requirements and the data model based on a group of data quality rules resulting in a verification.

In one or more embodiments, the method 300 can include the data ingestion server 100a, at 300e, generating, by the technology agent 200e, a connection to a data source associated with the service utilizing the AI software application. Further, the method 300 can include the data ingestion server 100a, at 300f, running, by the deployment agent 200f, a deployment pipeline to generate the data report. In addition, the method 300 can include the data ingestion server 100a, at 300g, receiving, by the validation agent 200g, data from the data source via the connection according to the data model. Also, the method 300 can include the data ingestion server 100a, at 300h, generating, by the validation agent 200g, the data report according to the group of requirements, the data report includes metadata.

In one or more embodiments, the method 300 can include the data ingestion server 100a, at 300i, determining, by the AI software application, a group of KPIs associated with the service from the data report. Further, the method 300 can include the data ingestion server 100a, at 300i, adjusting, by the AI software application, the service based on the group of KPIs.

Referring to FIG. 3B, in one or more embodiments, aspects of method 310 can be performed by the product owner agent 200b implemented by the data ingestion server 100a. The method 310 can include the product owner agent 200b, at 310a, performing data glossary lookup on data elements associated with a portion of the group of requirements utilizing the AI software application to determine that the data elements conform to organizational standards resulting in a group of glossary items. Further, the method 310 can include the product owner agent, 200b at 310b, updating the group of requirements with a first group of glossary identifiers (IDs) for the group of glossary items. In addition, the method 310 can include the product owner agent 200b, at 310c, requesting a group of new glossary items based on the group of requirements. Moreover, in some embodiments, the generating of requirements at 300b of method 300 can include performing data glossary lookup, updating requirements with a first group of glossary IDs and requesting new data glossary items.

Referring to FIG. 3C, in one or more embodiments, method 320 can be performed by the information architect agent 200c implemented by the data ingestion server 100a. The method 320 can include the information architect agent 200c, at 320a, generating the group of new data glossary items. Further, the method 320 can include the information architect agent 200c, at 320b, applying standardization logic to the group of new glossary items utilizing the AI software application. In addition, the method 320 can include the information architect agent 200 c, at 320c, validating group of glossary items and the group of new glossary items utilizing the AI software application. In some embodiments, the step of generating of the data model, at 300c, in method 300 can include generating new glossary items, applying standardization logic to the new glossary items and validating the existing and new glossary data items.

Referring to FIG. 3D, in one or more embodiments, aspects of method 330 can be performed by the data steward agent 200d and/or the product owner agent 200b implemented by the data ingestion server 100a. Method 330 can include the verifying requirements, at 300f, of method 300. Further, the method 330 can include the data steward agent 200d, at 330a, notifying the product owner agent 200b that there is a discrepancy in the verification. In addition, the method 330 can include the product owner agent 200b, at 330b, adjusting the group of requirements based on the discrepancy.

Referring to FIG. 3E, in one or more embodiments, aspects of method 340 can be performed by the technology agent 200e implemented by the data ingestion server 100a. The method 340 can include the technology agent 200e, at 340d, determining that there is no connection to the data source. Further, the method 340 can include the technology agent 200 e, at 340e, requesting for a connection to the data source. In addition, the method 340 can include the technology agent 200e, at 340f, validating of the connection to the data source. In some embodiments, the generating of the connection to the data source, at 300e, of method 300 can include determining that there is no connection to the data source, requesting a connection to the data source, and validating connection to the data source.

In one or more embodiments, once a connection to the data source is generated, the method 340 can include the technology agent 200e, at 340a, generating metadata associated with the data report. Further, the method 340 can include the technology agent 200e, at 340b, generating data definition language scripts for database tables for the data report. In addition, the method 340 can include the technology agent 200e, at 340c, notifying the deployment agent that the connection to the data source is generated.

Referring to FIG. 3F, in one or more embodiments, aspects of the method 350 are performed by the deployment agent 200f implemented by the data ingestion server 100a. The method 350 can include the deployment agent 200f, at 350a, validating the objects deployed in the pipeline based on the group of requirements. Further, in some embodiments, running the deployment pipeline, at 300f in method 300 of FIG. 3A, can include the validating the objects deployed in the pipeline based on the group of requirements.

Referring to FIG. 3G, in one or more embodiments, aspects of method 360 are performed by the validation agent 200g implemented by the data ingestion server 100a. The method 360 can include the validation agent 200g, at 360a, validating that data objects in the data report conform to the group of requirements. Further, in some embodiments, the generating of the data report, at 300h in method 300 of FIG. 3A, can include validating that the data objects in the data report conform to the group of requirements.

In one or more embodiments, the service can comprise at least one of loan origination service, fraud detection service, regulatory compliance service, customer relationship management service, risk management service, investment portfolio management service, financial reporting service, and payment processing service. In further embodiments, the adjusting of the service can comprise adjusting (automatically) one or more KPI thresholds associated with the service. Aspects of the automated services can continue of be prevented based on satisfying one or more of the KPI thresholds.

For example, the adjusting of the service comprises one of adjusting an approval rate threshold for the loan origination, adjusting a processing time threshold for the loan origination service, or adjusting a default rate threshold for the loan origination service. The loan origination service may be implemented by the service server 100b in an automated fashion such that satisfying thresholds associated with the approval rate, processing time, and default rate can prevent and approve a loan, accordingly.

In a further example, the adjusting of the service comprises adjusting a response time threshold for the fraud detection service. The fraud detection service may be implemented by the service server 100b in an automated fashion such that satisfying thresholds associated with the response time can prevent a credit card or debit card transaction and/or send a notification (e.g., email, text message, etc.) to the card holder, accordingly.

In an additional example, the adjusting of the service comprises adjusting a resolution time threshold for the customer relationship management service. The customer relationship management service may be implemented by the service server 100b in an automated fashion such that satisfying thresholds associated with the resolution time may expedite transferring a customer service call from a virtual assistant to a human customer service representative, accordingly.

In another example, the adjusting of the service comprises adjusting a risk exposure threshold for the investment portfolio management service. The investment portfolio management service may be implemented by the service server 100b in an automated fashion such that satisfying threshold associated with the risk exposure threshold can initiate electronic transaction to buy or sell assets (e.g., stock, bonds, etc.) to adjust the risk exposure for the investment portfolio, accordingly.

In a further example, the adjusting of the service comprises adjusting a processing time threshold to render payment for the payment processing service. The payment processing service may be implemented by the service server 100b in an automated fashion such that satisfying threshold associated with the processing time can expedite or delay rendering of electronic payment, accordingly.

While for purposes of simplicity of explanation, the respective processes are shown and described as a series of blocks in FIGS. 2B-2G and 3A-3G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. Further, one or more blocks in FIGS. 2B-2G and 3A-3G can be performed in response to one or more other blocks in FIGS. 2B-2G and 3A-3G.

Portions of some embodiments can be combined with portions of other embodiments.

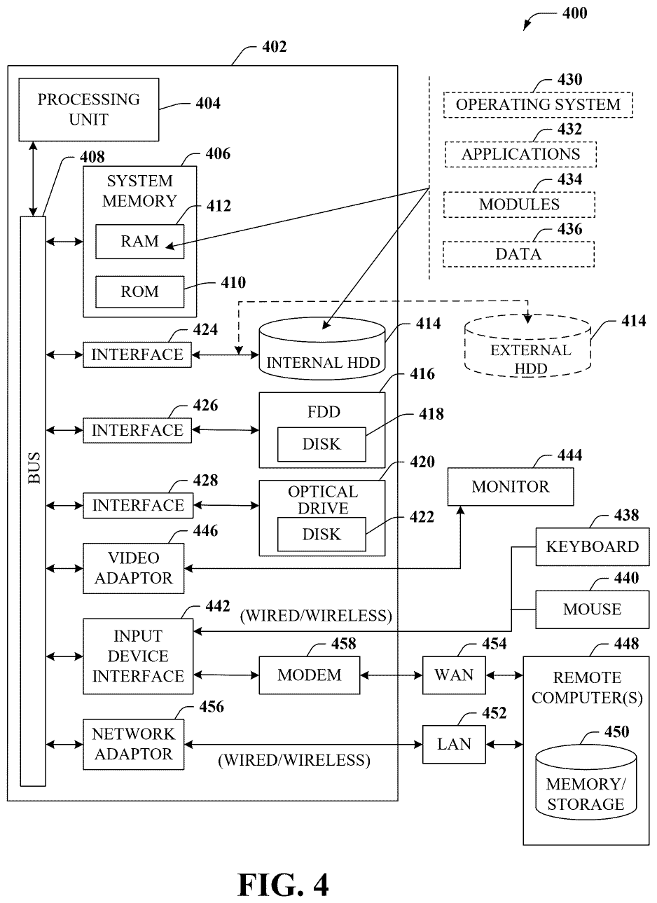

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, the computing environment 400 can be used in computing device described herein. Each of these devices can be implemented via computer-executable instructions that can run on one or more computers, and/or in combination with other program modules and/or as a combination of hardware and software. For example, computing environment 400 can facilitate providing a multi-agent framework to adjust automated services. Further, each of user computer 100e, data ingestion server 100a, and service server 100b can comprise aspects of computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

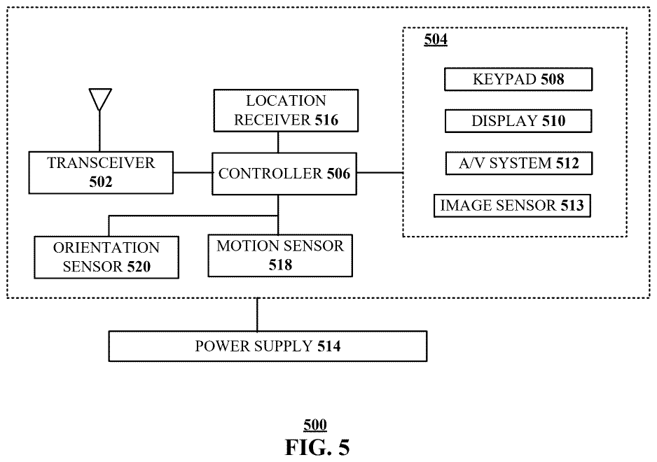

Turning now to FIG. 5, an illustrative embodiment of a communication device 500 is shown. Communication device 500 can facilitate in whole or in part providing a multi-agent framework to adjust automated services. Further, each of user computer 100e, data ingestion server 100a, and service server 100b can comprise aspects of communication device 500.

The communication device 500 can comprise a wireline and/or wireless transceiver 502 (herein transceiver 502), a user interface (UI) 504, a power supply 514, a location receiver 516, a motion sensor 518, an orientation sensor 520, and a controller 506 for managing operations thereof. The transceiver 502 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 502 can also be adapted to support circuit-switched wireline access technologies (such as PSTN), packet-switched wireline access technologies (such as TCP/IP, VoIP, etc.), and combinations thereof.

The UI 504 can include a depressible or touch-sensitive keypad 508 with a navigation mechanism such as a roller ball, a joystick, a mouse, or a navigation disk for manipulating operations of the communication device 500. The keypad 508 can be an integral part of a housing assembly of the communication device 500 or an independent device operably coupled thereto by a tethered wireline interface (such as a USB cable) or a wireless interface supporting for example Bluetooth®. The keypad 508 can represent a numeric keypad commonly used by phones, and/or a QWERTY keypad with alphanumeric keys. The UI 504 can further include a display 510 such as monochrome or color LCD (Liquid Crystal Display), OLED (Organic Light Emitting Diode) or other suitable display technology for conveying images to an end user of the communication device 500. In an embodiment where the display 510 is touch-sensitive, a portion or all of the keypad 508 can be presented by way of the display 510 with navigation features.

The display 510 can use touch screen technology to also serve as a user interface for detecting user input. As a touch screen display, the communication device 500 can be adapted to present a user interface having graphical user interface (GUI) elements that can be selected by a user with a touch of a finger. The display 510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 510 can be an integral part of the housing assembly of the communication device 500 or an independent device communicatively coupled thereto by a tethered wireline interface (such as a cable) or a wireless interface.

The UI 504 can also include an audio system 512 that utilizes audio technology for conveying low volume audio (such as audio heard in proximity of a human ear) and high-volume audio (such as speakerphone for hands free operation). The audio system 512 can further include a microphone for receiving audible signals of an end user. The audio system 512 can also be used for voice recognition applications. The UI 504 can further include an image sensor 513 such as a charged coupled device (CCD) camera for capturing still or moving images.

The power supply 514 can utilize common power management technologies such as replaceable and rechargeable batteries, supply regulation technologies, and/or charging system technologies for supplying energy to the components of the communication device 500 to facilitate long-range or short-range portable communications. Alternatively, or in combination, the charging system can utilize external power sources such as DC power supplied over a physical interface such as a USB port or other suitable tethering technologies.

The location receiver 516 can utilize location technology such as a global positioning system (GPS) receiver capable of assisted GPS for identifying a location of the communication device 500 based on signals generated by a constellation of GPS satellites, which can be used for facilitating location services such as navigation. The motion sensor 518 can utilize motion sensing technology such as an accelerometer, a gyroscope, or other suitable motion sensing technology to detect motion of the communication device 500 in three-dimensional space. The orientation sensor 520 can utilize orientation sensing technology such as a magnetometer to detect the orientation of the communication device 500 (north, south, west, and east, as well as combined orientations in degrees, minutes, or other suitable orientation metrics).

The communication device 500 can use the transceiver 502 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 500.

Other components not shown in FIG. 5 can be used in one or more embodiments of the subject disclosure. For instance, the communication device 500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving, by a product owner agent, user-generated input indicating a request for a data report for a product to adjust a service associated with the product;
generating, by the product owner agent, a group of requirements associated with generating the data report utilizing an artificial intelligence (AI) software application;
generating, by an information architect agent, a data model for generating the data report utilizing the AI software application;
verifying, by a data steward agent, the group of requirements and the data model based on a group of data quality rules resulting in a verification;
generating, by a technology agent, a connection to a data source associated with the service utilizing the AI software application;
running, by a deployment agent, a deployment pipeline to generate the data report;
receiving, by a validation agent, data from the data source via the connection according to the data model;
generating, by the validation agent, the data report according to the group of requirements, wherein the data report includes metadata;
determining, by the AI software application, a group of key performance indicators (KPIs) associated with the service from the data report; and
adjusting, by the AI software application, the service based on the group of KPIs.

2. The device of claim 1, wherein the generating of the group of requirements comprises performing, by the product owner agent, data glossary lookup on data elements associated with a portion of the group of requirements utilizing the AI software application to determine that the data elements conform to organizational standards resulting in a group of glossary items.

3. The device of claim 2, wherein the generating of the group of requirements comprises updating, by the product owner agent, the group of requirements with a first group of glossary identifiers (IDs) for the group of glossary items.

4. The device of claim 2, wherein the generating of the group of requirements comprises requesting, by the product owner agent, a group of new glossary items based on the group of requirements.

5. The device of claim 4, wherein the operations comprise generating, by the information architect agent, the group of new glossary items, wherein the generating of the group of new glossary items comprises applying, by the information architect agent, standardization logic to the group of new glossary items utilizing the AI software application, wherein generating the data model comprises generating, by the information architect agent, the data model based on the group of new glossary items utilizing the AI software application.

6. The device of claim 5, wherein the operations comprise validating, by the information architect agent, group of glossary items and the group of new glossary items utilizing the AI software application.

7. The device of claim 1, wherein the operations comprise:
notifying, by the data steward agent, the product owner agent that there is a discrepancy in the verification; and
adjusting, by the product owner agent, the group of requirements based on the discrepancy.

8. The device of claim 1, wherein generating of the connection comprises:
generating, by the technology agent, metadata associated with the data report;
generating, by the technology agent, data definition language scripts for database tables for the data report; and
notifying, by the technology agent, the deployment agent that the connection to the data source is generated.

9. The device of claim 8, wherein the operations comprise inserting, by the deployment agent, metadata into the data report.

10. The device of claim 1, wherein the generating of the connection comprises:
determining, by the technology agent, that there is no connection to the data source;
requesting, by the technology agent, for a connection to the data source; and
validating, by the technology agent, of the connection to the data source.

11. The device of claim 1, wherein the operations comprise validating, by the deployment agent, objects deployed in the deployment pipeline based on group of requirements.

12. The device of claim 1, wherein the operations comprise validating, by the validation agent, that data objects of the data report conform to the group of requirements.

13. The device of claim 1, wherein the service comprises at least one of loan origination service, fraud detection service, regulatory compliance service, customer relationship management service, risk management service, investment portfolio management service, financial reporting service, and payment processing service.

14. The device of claim 13, wherein the adjusting of the service comprises one of adjusting an approval rate threshold for the loan origination, adjusting a processing time threshold for the loan origination service, or adjusting a default rate threshold for the loan origination service.

15. The device of claim 13, wherein the adjusting of the service comprises adjusting a response time threshold for the fraud detection service.

16. The device of claim 13, wherein the adjusting of the service comprises adjusting a resolution time threshold for the customer relationship management service.

17. The device of claim 13, wherein the adjusting of the service comprises adjusting a risk exposure threshold for the investment portfolio management service.

18. The device of claim 13, wherein the adjusting of the service comprises adjusting a processing time threshold to render payment for the payment processing service.

19. A non-transitory machine-readable medium, comprising executable instructions that, when executed by a processing system including a processor, facilitate performance of operations, the operations comprising:
receiving, by a product owner agent, user-generated input indicating a request for a data report for a product to adjust a service associated with the product;
generating, by the product owner agent, a group of requirements associated with generating the data report utilizing an artificial intelligence (AI) software application;
generating, by an information architect agent, a data model for generating the data report utilizing the AI software application;
verifying, by a data steward agent, the group of requirements and the data model based on a group of data quality rules resulting in a verification;
generating, by a technology agent, a connection to a data source associated with the service utilizing the AI software application;
running, by a deployment agent, a deployment pipeline to generate the data report;
receiving, by a validation agent, data from the data source via the connection according to the data model;
generating, by the validation agent, the data report according to the group of requirements, wherein the data report includes metadata;
determining, by the AI software application, a group of key performance indicators (KPIs) associated with the service from the data report; and
adjusting, by the AI software application, the service based on the group of KPIs.

20. A method, comprising:
receiving, by a product owner agent, user-generated input indicating a request for a data report for a product to adjust a service associated with the product;
generating, by the product owner agent, a group of requirements associated with generating the data report utilizing an artificial intelligence (AI) software application;
generating, by an information architect agent, a data model for generating the data report utilizing the AI software application;
verifying, by a data steward agent, the group of requirements and the data model based on a group of data quality rules resulting in a verification;
generating, by a technology agent, a connection to a data source associated with the service utilizing the AI software application;
running, by a deployment agent, a deployment pipeline to generate the data report;
receiving, by a validation agent, data from the data source via the connection according to the data model;
generating, by the validation agent, the data report according to the group of requirements, wherein the data report includes metadata;
determining, by the AI software application, a group of key performance indicators (KPIs) associated with the service from the data report; and
adjusting, by the AI software application, the service based on the group of KPIs.
